(19) United States
(12) Patent Application Publication
(10) Pub. No.: US 2023/0135720 A1
(43) Pub. Date: May 4, 2023

(54) FOOTWEAR MIDSOLE AND RUNNING SHOE PRODUCED THEREWITH

(71) Applicant: Dieter MANKAU, Frankfurt am Main (DE)

(72) Inventor: Dieter MANKAU, Frankfurt am Main (DE)

(21) Appl. No.: 17/918,132

(22) PCT Filed: Apr. 9, 2021
(86) PCT No.: PCT/EP2021/059314

§ 371 Date: Oct. 11, 2022

(30) Foreign Application Priority Data
Apr. 9, 2020 (DE) 10 2020 002 235.9
May 22, 2020 (DE) 10 2020 003 058.0

(51) Int. Cl. A43B 13/12; A43B 13/18

(52) U.S. Cl. CPC A43B 13/125; A43B 13/183

(57) ABSTRACT

A shoe midsole for running shoes having spring/tread elements (2, 4, 4a), In order to achieve good damping and running support, it is proposed that a bow-shaped spring/tread element (2) is arranged on the underside in the forefoot region of the shoe midsole (1), which is fixed with a first end to the front end of the midsole (1) and with its other end to a first spring/tread element (4, 4a), of which the direction of movement is parallel to the extension of the midsole, so that it exerts a thrust force on the spring/tread element (2) when it springs out.

In accordance with the preamble of claim 1, the invention relates to shoe midsoles for running shoes with spring/damping elements.

In the majority of known damping systems for running shoes, there is no dependency or no control of the damping properties and the deflection, especially of the sole in the forefoot area or below the ball of the foot.

Typical damping elements are known from GB 2 179 235 A and US 2015/0 089 834 A1. US 4 910 884 A discloses a jumping device for attachment to the soles of ordinary shoes.

A damped sports shoe is known from CN 208 160 162 U, in which a number of spring elements is distributed over the entire length of the sole. These consist of pairs of spring elements attached to the outsole, which are connected to the midsole via thrust elements. Without the outsole, the midsole cannot be prefabricated, and the forces acting on the midsole are only vertically oriented, which provides good shock absorption but little dynamic advantage when running.

The object of the present invention is to improve a running shoe by creating a midsole that enables a well-adapted functional connection between the damping and running rhythm.

According to the invention, the object is achieved in that a bow-shaped spring/tread element is arranged on the underside in the forefoot area of the shoe midsole, and is fixed by a first end on the front end of the shoe midsole and by its other end on a first spring-damping element, whose direction of movement is parallel to the extension of the shoe midsole, such that it exerts a thrusting force on the spring/tread element during rebound.

The shoe midsole according to the invention has good damping properties, but, with the spring-damping element that is compressed when stepped on, and the elastically deformed spring/tread element, it provides energy stores that relax during the next step and thus make the energy usable for the runner. This is particularly evident in an arrangement in the region of the forefoot. This means that the ball of the foot is above the spring/tread element and the spring-damping element, set back behind the ball of the foot, and optionally also in the midfoot area.

The shoe midsole can be prefabricated as a unit and then integrated in the usual way into a shoe, which usually also has an inner sole, an outer sole, and upper material. The parts can be glued, and cavities can be filled with foam.

Particularly preferred is an embodiment of the invention in which a deflection limiting band which is subjected to tensile stress is provided between the shoe midsole and the spring/tread element, which deflection limiting band is attached by a first end on the front end of the shoe midsole and by its other end on a further spring-damping element or the first spring-damping element.

In contrast to the spring/tread element, this deflection limiting band is subjected to tensile stress and can be designed to be elastic or rigid in the tensile direction.

The deflection limiting band and its energy store made of metal compression springs or elastomer springs achieves a gentle and not-abrupt stopping of the sole deflection. Due to the constant push-off energy values in conjunction with a running speed and running rhythm once found, the running movement is carried out more fluently and without disturbances.

The present invention is therefore foot based on the object of further developing a cushioning system for applications in the field of running shoes in such a way that a particularly flexible use is made possible for different running styles and weight classes of runners.

Provision is preferably made for the cushioning system to be formed from at least one spring/damping element and at least one deflection limiting band and an energy store, wherein the functional relationship and the coupling between the spring/ damping element and the deflection limiting band is established via the energy store.

The deflection of the sole in the forefoot area is primarily controlled by the distance between the deflection limiting band and the shoe midsole, and the Shore hardness used and/or the spring characteristic of the spring in the energy store. Additional, but less-influencing factors have the flexural strength of the shoe midsole and the spring/damping element on the deflection capacity of the sole in the forefoot area.

The energy store can optionally be attached outside the spring/damping element or inside and/or under the spring/damping element.

Different shapes, spring stiffnesses, lengths, and the overall height of the spring/damping element can be used to provide different sole constructions corresponding to differentiated requirements for a running shoe.

The one-sided connection of the spring/damping element to the shoe midsole can be fixed or pivotable according to the differently shaped spring/damping element. A hinge is provided for a pivotable attachment, the term hinge meaning that the connection can be made with technically known different hinge-like formations. The spring/damping element can have different flexural strengths and can be made of different plastic materials. It preferably consists of carbon if no additional damping means such as foam is inserted between the shoe midsole and/or deflection limiting band and the spring/damping element.

If damping means such as foams are also inserted, the spring/damping element can be formed from medium-hard injection-mouldable plastics.

With this technical design, there is the possibility that the spring/damping element and the deflection limiting band can be produced as a coherent one-piece element. A prerequisite for this technical solution is that the foam hardness and the flexural strength of the spring/damping element are matched so that there is still a functional connection to the energy store. The spring/damping element can have different height gradients and shapes in the longitudinal direction of the shoe midsole according to the different running shoe requirements. The spring/damping element can be formed transversely to the central axis of the sole from two individual spring/damping elements, with one energy store to be used jointly, or from two separate energy stores. With two spring/damping elements and the associated energy stores, the individual running style as regards pronation and supination can be strongly influenced and corrected. The spring/damping element can have at least two guide elements on its freely displaceable side, laterally below the sliding edge, which are guided with low friction on the shoe midsole or in a part made of sliding plastic with guide grooves that is attached to the shoe midsole, in order to prevent a floating effect. In special cases, the spring/damping element can be moved on at least two rollers in this region, which preferably run in a guideway. If the deflection limiting band is formed from ropes, the guidance system is a forced guidance that prevents the spring/damping element from folding outward. The deflection limiting band can be guided in the energy store region with the left and right frame sides in a guide that is attached as a separate part to the shoe midsole. The guide part consists of a plastics material with good sliding properties.

Depending on special requirements, the deflection limiting band can itself have elastic properties and be made of carbon. For a running shoe suitable for everyday use, the deflection limiting band consists of a plastic fabric with components moulded thereon that are necessary for attachment to the shoe midsole, or that are directly necessary on the spring/damping element, and on the opposite side the moulded energy store that is technically designed for different spring variants.

For a comfortable, simple everyday shoe, the deflection limiting band itself can be designed as a spring at its free end behind the spring/damping element, and the additional spring inserted in the energy store can accordingly be dispensed with. In addition to using flat, wide, rectangular cross-sections for the deflection limiting band, one or more round ropes or narrow bands with pressed-on or injection-moulded fastening means can be used for the attachment to the shoe midsole and for the spring receptacles. The round ropes or narrow bands run in openings in the sliding edge on the spring/damping element, and are formed behind the sliding edge with appropriate receiving means for receiving compression springs. If the spring stiffness is to be changed mechanically via the spring, a limit stop for the spring/damping element on the deflection limiting band is necessary in order not to influence the curvature of the spring/damping element. Without a limit stop on the deflection limiting band, the compression spring can be moved by means of a mechanical adjustment device and the height and/or curvature of the spring/damping element can be changed as a result, with the spring characteristic remaining unchanged.

Different spring/damping elements are provided for different running shoe concepts. For a forefoot striker, the curved flat spring shape is preferably used for the damping system. For a midfoot striker, the combination of a curved flat spring with an arcuate section in the region of attachment to the sole is used. The damping system with an energy store attached inside or under the spring/damping element has the technical advantage that the spring/damping element, with its two arcuate sections, which are connected to one another by a curved flat spring section, can also be used advantageously in the midfoot and backfoot area. With a flat design and the use of additional damping means such as visco-elastic foams between the shoe midsole and/or the deflection limiting band and the individual spring/damping elements, a comfortable running shoe for everyday use can be realised.

Preferably a functional connection is established between all existing individual components that are used in the new shoe midsole concept

The shoe midsole is designed to be resilient in the forefoot area in the longitudinal direction, in a manner which is stable under pressure. The middle foot and backfoot area is continuously more stable in its hardness, and is harder in the spring effect than in the forefoot area.

In addition to the energy already stored in the spring/damping element, which is created by the impact load and the corresponding deflection of the spring/damping element, the resulting longitudinal displacement of the spring/tread element is deposited into an energy store at the freely movable end, wherein the thrusting pressure of the spring/damping element acts on the elastomer or metal compression spring in the deflection limiting band, and compresses it. The compression springs can be used in the production process according to the running shoe design, with springs of different Shore hardness or corresponding spring characteristics with corresponding damping properties.

Damping means made of different known materials and technologies with the corresponding damping properties can be arranged under the spring/damping element.

For a wide deflection limiting band, the damping means can be inserted solely between the spring/damping element and the deflection limiting band; or, if the deflection limiting band is formed from traction cables, can be inserted also between the spring/damping element and the shoe midsole.

The spring/damping element is accordingly arranged under the forefoot, middle and rear of the foot to meet the requirements of different running styles. On one end, the tread element is fixed, plugged-into, or pivotably connected to the shoe midsole. On the opposite free end, it is connected to the deflection limiting band via the energy store. In the event of an impact load on the spring/damping element, there is a longitudinal displacement of the spring/damping element at its sliding edge in the longitudinal direction of the sole, which sliding edge is coupled to the deflection limiting band via the energy store, and exerts pressure on the compression spring used in the energy store. The firm connection of one end of the spring/damping element to the shoe midsole can be effected by a swivel hinge, a stable living hinge, or by plug connections, gluing, riveting, screws or welding.

The damping means can preferably be formed from known PU foams with different Shore hardnesses and viscoelastic properties. It is conceivable that damping means solutions other than those of PU foams can be used, in accordance with today’s existing technological solutions for damping means.

The spring/damping element, in connection with the energy store and a shoe midsole that is resilient in the forefoot area, is primarily an energy store that stores the impact energy of the runner and then makes this energy available to the runner.

When the spring/damping element is subjected to impact pressure, part of the energy is stored in the spring/damping element, in the energy store, the shoe midsole, and - if the deflection limiting band itself is formed from a spring rod - in the deflection limiting band as well. If the damping structure element is also used in the midfoot area or in the back foot area, the distance between the deflection limiting band and the shoe midsole is greatly reduced, since the deflection limitation plays a subordinate role, especially in the midfoot area, with the exception of a minimal deflection limitation in the backfoot area. It is conceivable that the damping structure element for shoes for everyday use, especially in the forefoot and back foot area, is formed from two damping structure elements each, which are arranged transversely to the central axis of the shoe. In special cases, specially shaped individual elements for corrections in running style, or cleats for field sports, can be attached directly to the spring/damping element. If, for example, spring/damping elements are only attached to the shoe midsole in the forefoot area or in the forefoot and midfoot area, the remaining free areas must be closed off with known outsole sole shapes.

This invention does not encompass a holistic design solution of running shoes. It offers a new damping structure that can be attached to shoe midsoles. How the additionally necessary continuous outsoles or outsoles formed in partial segments could be formed technically and creatively is not the subject of this invention.

Today’s technical standard in the field of sports shoes for the production of continuous outsoles with high elastic deformability from known technical foams can be regarded as the prior art.

The different running styles, such as forefoot, midfoot and back foot strike, require different constructive / kinematic designs of the sole and the damping of the foot. The back foot strike style needs an extra, good damping system.

The direction of impact when the foot strikes the ground goes directly into the joints and spine. There is little use of the body’s own damping apparatus, and there is a slight braking effect during running. The most common running style is the midfoot strike. The ball of the foot and the heel are evenly loaded when the foot touches down. The angle of inclination of the runner is slightly forward in this running style. The roll-off energy is transferred evenly into the leg. The force of the impact is dissipated via the leg into the hip and back. The stride frequency plays a significant role in the roll-off behaviour and impact load of the foot. In the forefoot striker, the angle of inclination is strongly tilted forward. A runner using a forefoot strike has the best endogenous damping properties. The first contact with the ground takes place on the ball of the foot. The calf muscles and the Achilles tendon tense, the arch of the foot stretches. At push-off, a large part of the energy remaining in the muscles and tendons is released again. This means that part of the kinetic energy of the previous step is returned to the following step. The disadvantage of forefoot running is that it puts a lot of strain on the muscles. The calf region and the foot muscles have to work harder than with midfoot and heel strikes. Forefoot/midfoot strikers require less damping; as a result, forward propulsion can be increased.

The spring properties of the sole are sometimes more important than the damping. Soft to medium-firm soles are often made from foamed plastics. A differentiated compression modulus for the sole of the shoe is usually determined by a different sole thickness. In addition, cavities or recesses in the sole can be used to implement functions such as region boundaries between the front of the foot and the rear of the foot in the sole. As a rule, soft foam, air or gel damp inserts are used for damping. The damping impact direction is usually perpendicular to the outsole. As the stability of the sole increases, the shock absorbing properties of the sole decrease. Stability properties and shock absorbing properties should ideally be in balance. A significant influencing factor is the different weight of users with the same shoe size. The parameters of hardness and damping that are set during production for this shoe size cannot compensate for the large weight differences of the running shoe users, even with an ideal design of the construction.

The present invention also relates to a midsole construction which, in its biomechanical design, enables a significant improvement in its shock-absorbing properties via a combination of energy-storing spring/tread elements, damping structure elements, and a coupled device for individual hardness adjustment and damping adjustment.

These factors have a strong influence on the roll-off behaviour of the running shoe.

The object is achieved by a shoe midsole structure having one or more spring/tread elements with underlying damping structure elements and a hardness/damping system with which it is possible to modify the individual damping and hardness parameters. The term hardness/damping system is synonymous with a spring/damping element. In addition to the energy already stored, which is created by the impact load and the corresponding deflection of the spring/tread element, the resulting longitudinal displacement of the spring/tread element at its freely movable end is directed into a hardness/damping system, such that the sliding pressure of the spring/tread element acts on the elastomer compression spring and compresses it. The elastomer compression springs can be changed or exchanged for springs with different Shore hardnesses with corresponding damping properties. Alternatively, steel compression springs can be used instead of elastomer compression springs. Instead of compression springs, elastomer tension springs, which are arranged below the spring/tread element, can also be used.

In their biomechanical function, the damping and hardening elements amplify the roll-off movement of the foot and return the stored energy that is created by a foot step and the associated impact load on the spring/tread elements and that is also temporarily stored in a compression or tension spring in the form of energy, to the runner in the subsequent step, as additional energy for propulsion. The spring/tread element can have different spring characteristics as well as differently designed spring shapes for use in different running shoe designs. The technical design of a provided spring/tread element corresponds to a curved flat spring. Another resilient tread variant is formed from a combination of a bow spring and a curved flat spring. A third is a double-acting flat spring designed for walking and sprinting. All variants have a progressive spring characteristic which can be reinforced by the hardness/damping system with appropriate compression or tension springs. There is a strong interaction upon an impact load on the compression or tension spring in the hardness/damping system in the spring/tread element with the curved flat spring characteristic. The attachment of the spring/tread elements on the opposite side of the hardness/damping system on the shoe midsole is therefore different. The spring/tread element with the curved flat spring characteristic is attached to the front or rear attachment point on the shoe midsole, but can be pivotably or rotatably attached as well if desired. It can be inserted and glued into a receiving guide at the front or in the backfoot area of the shoe midsole, or it can be inserted into an elastomer receiving bearing that is firmly anchored in the receiving guides on the shoe midsole. The spring/tread element in the combination of a bow and curved flat spring is preferably firmly connected to the shoe midsole.

Three different running shoe constructions are specified at the factory, with the exception of the compression or tension springs used in the hardness/damping system. A backfoot-strike running shoe for a normal, easy run, a midfoot-strike running shoe for an athletic run, and a forefoot-strike running shoe for high-performance running.

The shoe midsole itself remains structurally unchanged for all weight classes of a shoe size, and is specified during the production process. Various combinations and arrangements of spring/tread elements and damping structure elements for different running styles, with the possibility of later individual adjustment, are also specified during the production process. The fine-tuning of hardness, flex, and damping is done by replacing elastomer or steel compression and tension springs with different degrees of hardness and damping capacity in the hardness/damping system.

The shoe midsole is designed to be resilient in the forefoot area in the longitudinal direction, in a manner which is stable under pressure. The middle foot and backfoot area is continuously more stable in its hardness, and is harder in the spring effect than in the forefoot area. For all running shoe constructions, a low “drop” is provided, with the exception of the increased middle spring/tread elements, such that economical running is possible in all athletic disciplines.

Structural damping elements made of different known materials and technologies with the corresponding damping properties can be arranged under the spring/tread elements. Structurally, the damping structure elements are designed in such a way that a shift in the tangential and vertical direction is possible, but a transverse shift is largely prevented. With this technical shaping of the damping structure elements, a floating effect is prevented. The damping structure elements can preferably be produced by 3D printing from TPU or silicone with different Shore hardness and viscoelasticity. Large, open-pored or connected spatial structures are particularly light and particularly effective in terms of their damping capacity. Spatial damping structures can form the damping structure element, for example in a modified form of hexagonal wave springs which are combined in a honeycomb composite system. Differentiated hardness and damping properties can be realised through the number of windings of the waves, and the wave sizes. In special cases, the professional runner can be provided with shoes that do not have any built-in damping structure elements, instead giving the runner a choice to also use other damping systems such as gels, liquids or air. Theoretically, the other assemblies or their individual parts can also be made available to the athlete as separate parts. So that the damping structure elements are not compressed too much when the spring/tread elements deflect, there are strip-shaped elevations under the spring/tread elements on the sole, running transversely to the central axis, which limit the deflection and prevent a floating effect when pushing off. These height deflection limitations can also be attached to the spring/tread element. Alternatively, spacer elements can be inserted into the damping structure element itself, which define a fixed deflection limit for the spring/tread element. These advantageously consist of medium-hard elastomer compression springs, and can be shaped cylindrically, in strips, with concave, convex or other free-form profiles. The strip-shaped spacer elements run transversely to the central axis, and the cylindrically shaped elastomer springs are arranged on the central axis or as a pair to the left and right of the central axis between the spring/tread element and the shoe midsole. A convex, strip-shaped web running transversely to the central axis has the advantage that the principle of the “tilting technique” is achieved with high stability for the runner when running in curves or with a strong lateral foot inclination.

The spring/tread elements are arranged under the forefoot, midfoot and backfoot to meet the needs of different running styles. They are prestressed and form an arch. On one end, the tread element is fixed, plugged-into, or pivotably connected to the shoe midsole. On the opposite free end, a wide guide strip leads to the hardness/damping system with the exchangeable elastomer compression springs. Upon an impact load on the spring/tread element, there is a longitudinal displacement of the spring/tread element in the longitudinal direction of the sole, which presses with the wide guide strips into a hardness/damping adjustment system on an elastomer spring compression spring. One side of the tread element can be firmly connected to the shoe midsole by a stable living hinge, or by plug connections, gluing, riveting, screwing or welding. This fixed arrangement is preferably carried out -for example, for the forefoot strike running shoe - at the forefoot tip of the shoe midsole. The forefoot tip of the shoe midsole is usually pulled further forward so that there is optimal efficiency for the deflection of the spring/tread element.

The spring/tread element can be formed in the longitudinal direction of the sole from two or three spring/tread elements arranged side by side. This division allows a strong correction of pronation or overpronation through different spring stiffnesses of the individual spring elements or through different Shore hardnesses of the elastomer compression springs used in the hardness/damping system. A correction that is suitable for everyday use can also be achieved by changing the cross-section of the spring/tread element transversely to the central axis of the sole. The spring/tread element can be given pressure-point elastic properties through wavy constrictions transverse to the central axis. These constrictions allow the spring/tread element to bend in the longitudinal direction of the sole, even with different curvatures transverse to the central axis. The material for the spring/tread element is preferably formed from carbon.

Spring/tread elements manufactured by a plastics injection moulding process are also suitable for medium loads with the appropriate proportion of carbon fibres.

For leisure running shoes, the spring/tread elements can be made of medium-elastic plastic in conjunction with harder damping structure elements.

The hardness/damping system is a separate part that can be glued, welded, or screwed to the shoe midsole, or inserted into an existing guide on the shoe midsole. If the shoe midsole consists of a plastic injection-moulded part, the hardness/damping system can be injected at the same time. In the hardness/damping system, different elastomer springs with different Shore hardnesses with different viscoelastic properties can be changed later by the customer or in a specialist shop. By choosing different Shore hardnesses and damping properties of the compression or tension springs, a single shoe size is able react to different weights of runners, and an individualised running adaptation can be made. If harder elastomer springs are used, for example, heavier runners can be better served by the shoe system as a whole. A mechanical displacement of the elastomer springs in order to achieve higher compression and thus greater hardness of the elastomer spring can also be achieved using known engineering principles suitable for the formation of a hardness/damping system. When it is screwed to the shoe midsole, the hardness/damping system can have longitudinal slits or a plurality of bores that allow the hardness/damping system to be positioned differently on the longitudinal axis of the shoe midsole. Ideally, the shoe midsole is designed in such a way that it has the known ergonomic requirements for an outsole. A change in these general parameters is present in the forefoot area of the sole, which, in combination with the spring/tread element, acts as an additional spring. Through the use of spring/tread elements with different hardness and damping, and the damping structure elements that are attached between the spring/tread element and the shoe midsole, and with the elastomer springs available with hardness/damping systems with different Shore hardnesses and damping properties, very different requirements for the running shoe can be met. The spring/tread element in the forefoot area, in connection with the hardness/damping system and a shoe midsole that is resilient in the forefoot area, is primarily an energy store that stores the impact energy of the runner and makes this energy available to the runner again.

When the spring/tread element is subjected to an impact load, part of the energy goes into the hardness/damping system, into the compression or tension spring, and, if the sole is designed as a spring in the forefoot area, a part can pretension it and also support the forward movement of the runner. The vertical forces are transferred into a horizontal acceleration. For a midfoot striker, the arrangement and number of spring/tread elements is different than that of a forefoot striker. For a midfoot striker, a second spring/tread element is provided in the backfoot area in addition to the spring/tread element arranged in the forefoot area. A third spring/tread element in the midfoot area, which protrudes a little higher than the spring/tread element arranged in the front and backfoot, is advantageous for a athletic runner. Even the forefoot striker does not have any disadvantages in running behaviour due to this arrangement of the spring/tread elements. The spring/tread element for the midfoot area can also be inserted without its own hardness/damping system by attaching it centrally to the front and rear spring/tread element at the central height of the spring/tread elements. Depending on the spring stiffness and shape of the middle spring/tread element, there is a functional connection between all three spring/tread elements. It can be attached using living hinges, hinges, rivets, adhesives, plug-in connections or in the same material during the production process. The spring stiffness and shape of the middle spring/tread element is determined by the running style and where the shoe is used. For special athletic running applications, such as a long-distance run on paved, smooth roads, a damping structure element under the central spring/tread element can be dispensed with.

A running shoe for a hindfoot striker substantially corresponds to that of a forefoot striker, but the spring/tread element in the backfoot area requires significantly more damping than for the middle and forefoot strikers. Most runners land on their heels and roll off their forefoot. Alternatively, to achieve optimal damping, the hardness/damping system can be arranged above the sole in the backfoot area. The spring/tread element in the heel can have pressure point elastic properties for special athletic applications, which can be realised by wave-shaped constrictions transverse to the central axis.

For athletic use, the spring/tread elements have an outsole covering with high static friction on their underside, which is inclined towards the ground. Experience has shown that the structuring and shape of the covering is selected in such a way that it meets the specific requirements for the respective athletic uses. Special outsole coverings that deviate, for example, from the height profile of the spring/tread elements specified in production can be individually manufactured using 3D printing and adapted to the individual running style of the runner. In addition, the basic damping capacity in the backfoot or forefoot area can be fine-tuned by setting new contact or roll-off points.

It is conceivable that known hook-and-loop (Velcro) fasteners are used to attach the outsole to the spring/tread element or the shoe midsole in order to carry out a differentiated adjustment for different athletic requirements with little effort.

The sole covering material is also an important factor for the different uses of the shoes. The spectrum ranges from soccer shoes equipped with cleats to shoes used for various indoor sports. The fact that the shoe allows a slight lateral inclination when the foot strikes at an angle gives the athlete more reliable stability and better grip on the ground. For everyday athletic use, a continuous outsole with high elastic deformability made of well-known technical foams that have proven themselves in the field of sports shoes is to be used during the production process; recesses that can be closed off are provided in the areas where the hardness/damping systems are located. Individual areas such as the midfoot area or the hindfoot area can be supplemented or closed off with a partial outsole, for example. The deformations in the tangential and vertical direction caused by compression in the outsole are removed without tension by bellows-like formations in the lateral region of the outsole.

A different height of the individual spring/tread elements can strongly influence the individual running styles. If the spring/tread element located in the midfoot area is higher than the front spring/tread element, the body leans forward more, which in combination with the front spring/tread element leads to an accelerated roll-off movement and forward movement. The biomechanical advantage is that the push-off energy during running is not only applied via the forefoot, but from the midfoot area with this arrangement more than usual, and - in a small proportion - if a spring/tread element is arranged as a bridge between the front and rear spring/tread elements, also from the backfoot area. The same also applies to different heights and transverse gradients of the outsole, based on the height gradient of the spring/tread elements used.

In addition to use in the sports shoe sector, the basic technical principle is also conceivable for applications that place physically similar requirements on a hardness and damping system. For example, this system could be used under a ski binding plate or under a snowboard binding. In addition to athletic use, applications for normal shoes are also intended for people who often carry loads at work and walk many meters. The fact that the entire system has to be redesigned and adapted for the given intended use does not affect the existing functional relationship.

The invention will be explained in more detail below using embodiments in conjunction with drawings that are designed as illustrations of principles, the invention not being limited to the illustrated embodiments. In the drawings:

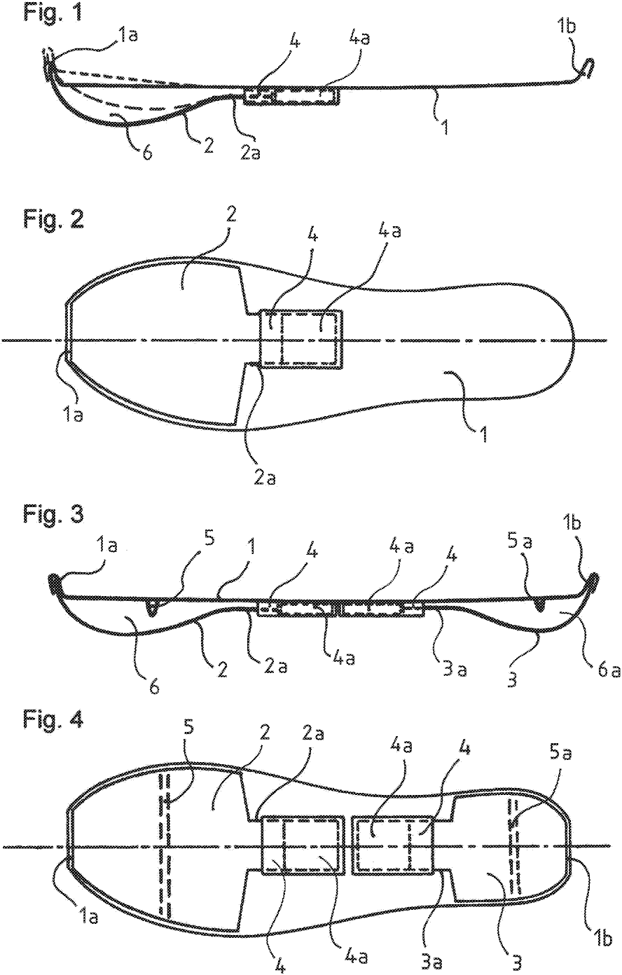

FIG. 1 is a side view of a shoe midsole with a shoe midsole tensioned upwardly in the forefoot area, a spring/tread element located in the forefoot area, a damping structure element that is not, shown and a hardness/damping system that is arranged in the midfoot area.

FIG. 2 is a bottom view of FIG. 1;

FIG. 3 is a side view of a shoe midsole with a spring/tread element arranged in the forefoot and backfoot area, with a damping structure element in the forefoot area, a damping structure element (not shown) in the backfoot area, and two associated hardness/damping systems.

FIG. 4 is a bottom view of FIG. 3;

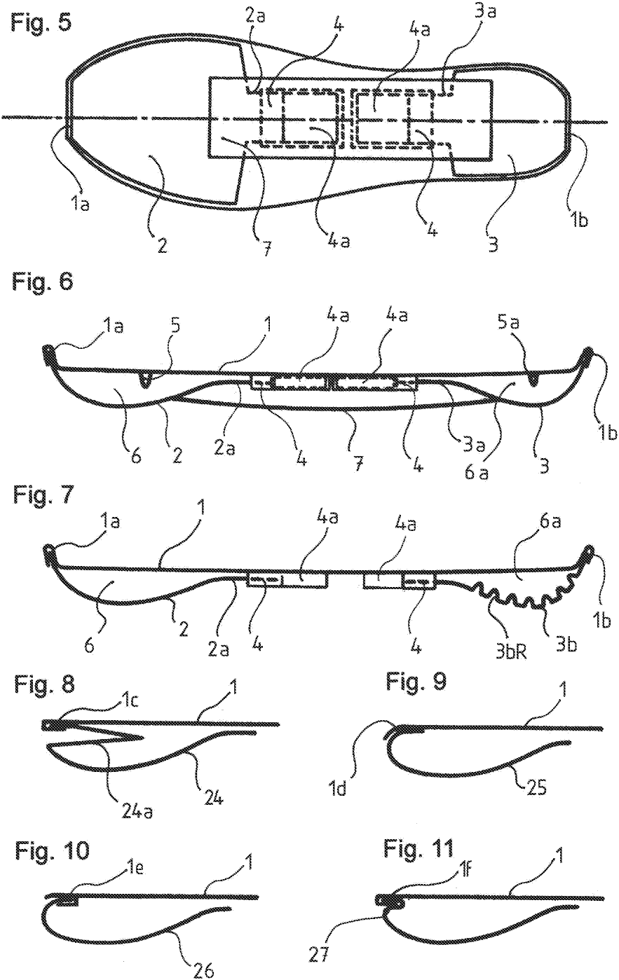

FIG. 5 is a bottom view of FIG. 6;

FIG. 6 is a side view of a shoe midsole with a spring/tread element arranged in the forefoot and backfoot area, with a damping structure element in the forefoot area, and a damping structure element (not shown) in the backfoot area, the hardness/damping system functionally belonging thereto, and a spring/tread element without its own hardness/damping system, attached firmly but flexibly to the front and rear spring/tread elements bridging the midfoot area, and two spacers attached below the shoe midsole and the spring/tread elements.

FIG. 7 is a side view of a shoe midsole with a spring/tread element arranged in the forefoot area, with a damping structural element (not shown), and a hardness/damping system, a wave-shaped spring/tread element arranged in the backfoot area, a damping structural element (not shown), and the spring/tread element on the shoe midsole in the rear backfoot area above the shoe midsole inserted firmly in a flexible elastomer bearing, and runs with the opposite side in the midfoot area of the shoe midsole into a hardness/damping system.

FIG. 8 is a side view as a detail of a double-acting spring/tread element in the forefoot and/or backfoot area arranged, underneath the shoe midsole, firmly plugged into a receiving guide at the toe and/or in the backfoot area.

FIG. 9 is a side view as a detail of a shoe midsole with an arched spring/tread element arranged in the forefoot and/or backfoot area, which is firmly connected to the sole below the shoe midsole at the toe and/or in the backfoot area.

FIG. 10 is a side view of a spring/tread element like FIG. 9 but fixed in a flexible elastomer bearing below the shoe midsole at the toe.

FIG. 11 is a side view as a detail of a shoe midsole with an arched spring/tread element arranged in the forefoot and/or backfoot area, which is firmly connected to the sole below the shoe midsole at the toe and/or in the backfoot area.

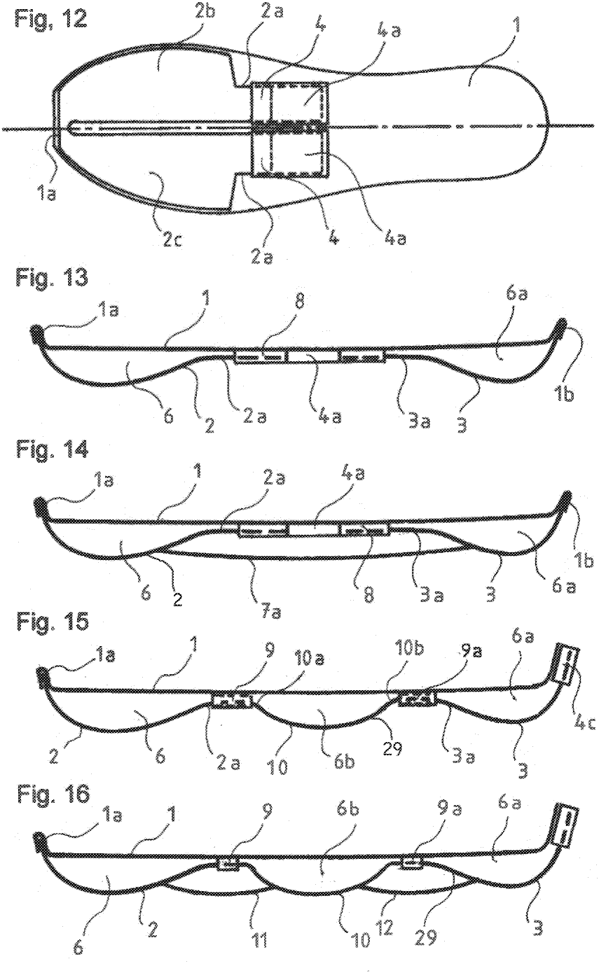

FIG. 12 is a bottom view of a shoe midsole with a spring/tread element arranged in the forefoot, that is divided into two adjacent hardness/damping systems arranged in the longitudinal direction relative to the shoe midsole and in the midfoot area of the shoe midsole.

FIG. 13 is a side view of a shoe midsole with a spring/tread element arranged in the forefoot and backfoot area, with a hardness/damping system in a midfoot guide element.

FIG. 14 is a side view of a shoe midsole with a spring/tread element arranged in the forefoot and backfoot area with a hardness/damping adjustment system in a guide element in the midfoot area and with a spring/tread element without its own hardness/damping system which is firmly but flexibly attached on the front and rear spring/tread element, bridging the midfoot area.

FIG. 15 is a side view of a shoe midsole with a continuous spring/tread element located in the forefoot, midfoot, and backfoot regions with two guide elements at the transition point from the forefoot to midfoot and from the midfoot to backfoot region, and a hardness/damping system in the backfoot region above the shoe midsole.

FIG. 16 is a side view of a shoe midsole with a continuous spring/tread element arranged in the forefoot and hindfoot area with two guide elements at the transition point from the forefoot to the midfoot and from the midfoot to the hindfoot area and a hardness/cushioning system in the backfoot area above the shoe midsole with two spring/tread elements without their own hardness/cushioning system which are fixed but movable between the front and middle and middle and rear spring/tread elements.

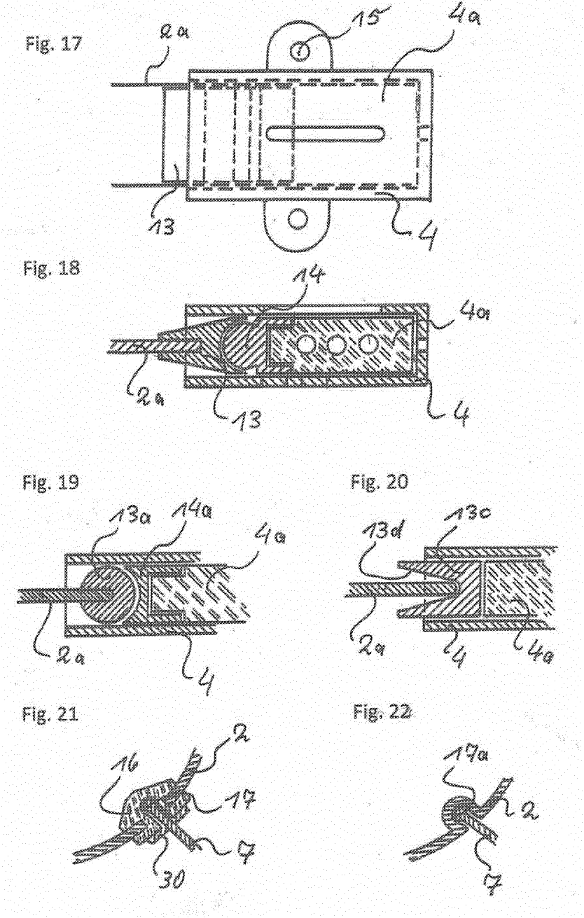

FIG. 17 is a bottom view of a hardness-cushioning system with elastomeric compression spring and mounting tabs for attachment to a shoe midsole.

FIG. 18 is a sectional side view of FIG. 17

FIG. 19 is a side view as a section and detail of a technical solution for introducing a wobbling thrust motion into the hardness/damping system with elastomer spring

FIG. 20 is a side view as a section and detail of a technical solution for introducing a wobbling thrust motion into the hardness/damping system with elastomer spring.

FIG. 21 is a side view as a section and detail of a technical solution for introducing a wobbling thrust motion into an elastomeric bearing that is created by a spring/tread element without a hardness/damping system which is fixed but movable between a front and a rear spring/tread element.

FIG. 22 is a side view as a section and detail of an engineering solution for introducing a tumbling thrust motion that is created by a spring/tread element without a hardness/damping system but movably mounted between a front and a rear spring/tread element fixed.

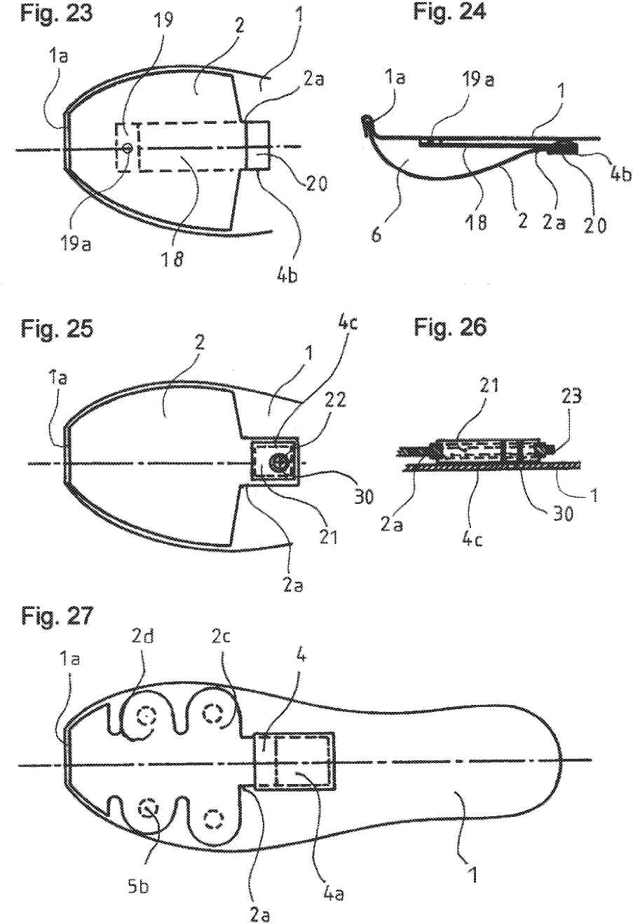

FIG. 23 is a bottom view of a shoe midsole with a spring/strike element arranged in the forefoot. spring/tread element with elastomer tension spring extending below the spring/tread element.

FIG. 24 is a side view of FIG. 23.

FIG. 25 is a bottom view of a shoe midsole with a spring/tread element arranged in the forefoot with a compact elastomer spring that is fixed but movably attached to the spring/tread element and to the shoe midsole.

FIG. 26 is a side view as a section and detail of FIG. 25.

FIG. 27 is a bottom view of a shoe midsole with a spring/strike element arranged in the forefoot. spring/strike element arranged in the forefoot, which has wing-shaped formations transverse to the central axis and cylindrical spacers arranged under the wing-shaped formations.

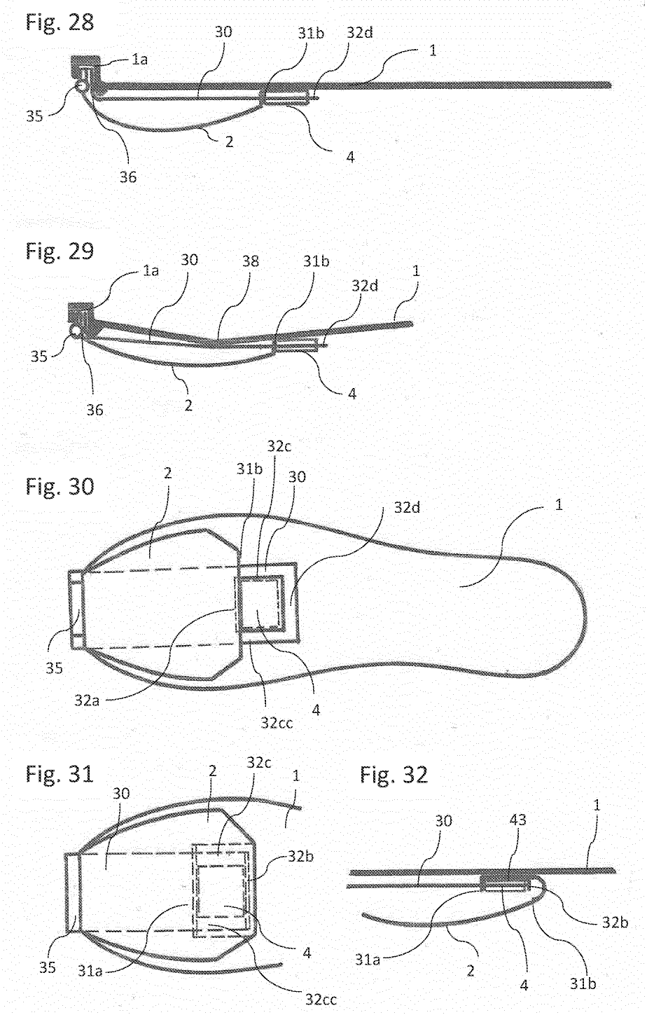

FIG. 28 is a side view of a shoe midsole with a damping structure element arranged in the forefoot area

FIG. 29 is a side view of the shoe midsole of FIG. 1 with damping structure element arranged in the forefoot area in the deflected state

FIG. 30 is a bottom view of FIG. 1 and FIG. 2 with an energy storage device arranged outside the shock absorber in the midfoot area

FIG. 31 is a bottom view of a shoe midsole as a section with a damping structure element arranged in the forefoot area whose energy storage is arranged below the shock absorber

FIG. 32 is a side view as a detail of FIG. 4

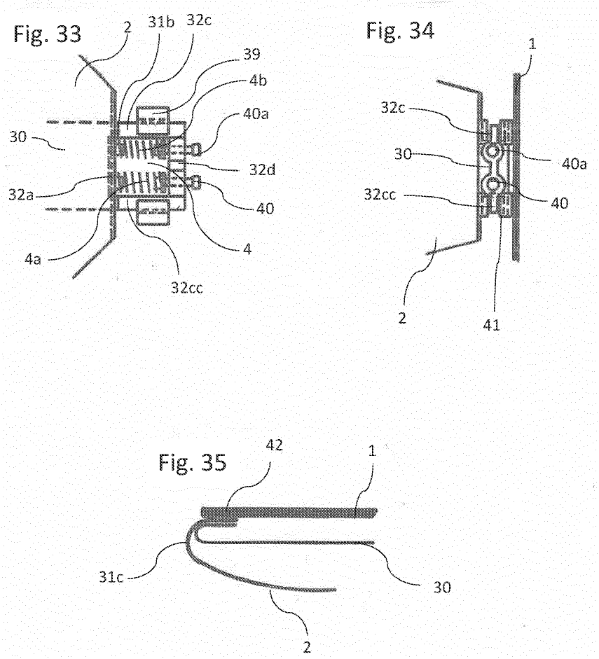

FIG. 33 is a detailed view of an energy storage unit with 2 metal compression springs which can be manually adjusted in hardness.

FIG. 34 is a detail view of the energy accumulator of FIG. 6 as a rear view.

FIG. 35 is a detailed side view of an alternative connection of a shock absorber and a deflection limiting band to the midsole of the shoe at the toe of the sole.

FIGS. 1 and 2 show a shoe midsole (1) on which a spring/tread element (2) with a spring/damping element (4) in which an elastomer compression spring (4a) is arranged. When an impact load is applied to the spring/tread element (2), part of the impact energy goes into the spring/damping element (4) on the compression spring (4a) and part goes into the deflection of the shoe midsole (1) in the forefoot area. The spring/tread element (2) is inserted at the toe of the shoe sole into a receptacle (1a) located above the shoe midsole and firmly connected to the sole. This type of connection allows a flat spring design of the spring/tread element and thus a direct impact pressure load on the compression spring (4a) in the hardness/damping element (4). Alternatively, the fastening can also be in the form of a hinge. The damping structure element (6) and the spacer elements (5, 5a) are not shown in these two figures.

FIGS. 3 and 4 show a shoe midsole (1) with a spring/tread element (2) arranged in the forefoot area and a spring/tread element (3) arranged in the hindfoot area with the associated hardness-damping systems (4) and a damping structure element (6) between the shoe midsole (1) and the spring/tread element (2) arranged in the forefoot. The damping structure element (6a) is not shown in FIG. 3.

The spacer elements (5, 5a), which are attached to the shoe midsole (1) and run transversely to the central axis of the sole (1) under the spring/tread elements (2, 3), can be concave or convex transversely to the central axis of the sole (1) and can be formed from medium-hard elastomers. A convexly shaped spacer element (5, 5a) allows a slight lateral inclination of the shoe with good stability when an impact load is applied to the spring/tread element (2, 3). A concave spacer element (5, 5a) does not allow the shoe to tilt when impact loads are applied to the spring/tread element (2, 3), but it does allow the shoe to stand securely. The damping structure element (6, 6a) has through-holes at the points where the spacer elements (5, 5a) are fitted, so that the spacer element can be supported directly on the shoe midsole (1) and the spring/tread element (2, 3). The spacer elements (5, 5a) may also be incorporated in the damping structure element (6, 6a). The spring/tread elements (2, 3) are attached to the shoe midsole as in FIGS. 1 and 2. The hardness-damping system (4) is identical for both spring/tread elements (2, 3) except for the compression spring (4a), which may have a different Shore hardness and shape.

The basic structure of FIGS. 5 and 6 corresponds to FIGS. 3 and 4 except for the spring/tread element (7). The spring/tread element (7) bridges the mid-foot area and is firmly but movably connected to the two spring/tread elements (2, 3). The fastening can be realized by plug-in connections as in FIGS. 21 and 22 or as a coherent component of spacer element (7) and the spring/tread element (2) and (3). Hinges are also provided on the spring/tread element (7, 2 and 3). The width, hardness-damping system and shape of the spring/tread element (7) are determined by the sporting use and the running style of the runner. The damping structure element (6e) under the spring/tread element (7) can be freely selected in terms of its size and damping properties and in relation to the spring/tread element (7). The spring/tread element (7) creates a kinetic energy coupling between the spring/tread element (2) in the forefoot area and the spring/tread element (3, 3b) in the hindfoot area.

The impact energy acting on the spring/tread element (3, 3b) during heel strike is primarily transferred to the hardness-damping system (4) in the compression spring (4a) and with the same thrust movement to the spring/tread element (7), which is slightly preloaded and introduces this energy into the spring/tread element (2), which is slightly preloaded and transports part of the kinetic energy into the sole tip (1a) of the shoe midsole (1) and causes it to deflect. When the foot rolls in the direction of travel over the spring/tread element (7), the impact pressure on the spring/tread element(2) mounted in the forefoot increases sharply. This causes the spring-loaded sole in the forefoot area to deflect even further. The additional kinetic energy generated by the foot pushing off via the spring/tread element (2) mounted in the forefoot leads to greater deflection of the sole in the forefoot area (1a) of the shoe midsole. The spring energy stored in the sole in combination with spring energy generated when the foot pushes off in the spring/strike element (2) is made available to the runner to accelerate the forward movement. In the case of a forefoot runner, part of the kinetic energy generated by the impact load of the spring/tread element (2) located in the forefoot area is stored in the spring/tread element (7) and (3, 3b) and made available as additional energy for pushing off the foot in the running direction. In the case of a midfoot runner, the spring/tread element (7) should be higher on the side facing the ground than the height of the spring/tread element(2) and (3, 3b). The spring/tread element (7) is the first to make contact with the ground when the foot touches down and can store the available touchdown energy first and feed it into the spring/tread element (2) and (3, 3b) in equal parts and make the stored kinetic energy available to the runner again for its forward movement, as described for the rear foot runner. The higher spring/tread element (7) additionally reinforces the rolling motion of the foot in the running direction.

The damping structure element in the area of the spring/tread element (7) is adapted in its damping properties and its shape to the curvature and existing spring hardness of the spring/tread element (7). The damping and hardness properties of the compression springs (4a) in the hardness-damping system (4) are to be adapted to the running styles.

FIG. 7 shows an example of the spring/tread element (3b) with a wave-shaped spring. These wave-shaped indentations can be used to realize differentiated pressure point elastic deformations with low compressive strength in the longitudinal direction of the spring-appearing elements. If the wave-like indentations extend to below the lowest point of the spring/tread elements, which are concave or convex in the transverse direction to the center of the sole, deflection in the longitudinal direction of the sole is given. If there is only an undulating indentation, a limited, hinge-like deflection occurs, e.g. in the spring/tread element (7), which is located at its ends, at the attachment points to the spring/tread elements (2) and (3, 3b). The compression spring (4a) in the hardness-damping system (4) is provided with a lower Shore hardness in this design of the spring/tread element (3b).

FIGS. 8, 9, 10 and 11 show spring/tread elements (24, 25, 26, 27) showing different connection solutions (1c , 1d, 1e, 1f) to a shoe midsole (1). In FIG. 8, the spring/tread element is inserted below the sole into a receptacle (1c) and firmly connected to the shoe midsole. The spring/tread element (1c) has two graduated spring characteristics due to its “dual spring” design.

When an impact load is applied to the spring/strike element (24), the first stage (24a) of the spring reacts with low spring pressure. In the second stage, as pressure is applied to the spring/tread element (24), the spring characteristic becomes harder and releases the resulting pressure energy into the hardness-damping system (4, 4b, 4c, 4e,4d) and into the deflection of the shoe midsole (1) in the forefoot area (1c). This spring/tread element (24) can be used to form a running shoe which, in addition to its sporting use, also has good spring and damping properties for quiet comfortable running. The spring/tread element (24), like the spring/tread elements (2, 2b, 2e, 25, 26, 27), can be used in the hindfoot area.

FIGS. 9 and 10 show a spring/tread element (25) which is shaped in the form of an arch and is firmly attached in the lower region (1d) of the shoe midsole (1). This spring/tread element (25) corresponds in its arcuate design to a classic arcuate spring and can thus be effectively influenced in its spring characteristic curve by different compression and tension springs (4a,18,21) in the hardness-damping system (4, 4b, 4c, 4d). The spring/tread element (26) is inserted underneath the sole in a receptacle (1e) and firmly connected to the midsole of the shoe.

The spring/tread element (27) in FIG. 11 has an attenuated arcuate shape and is therefore harder than the spring/tread elements (25, 26) and acts more directly on the springs (4a, 18, 21) in the hardness-damping system (4, 4b, 4c, 4d) than the spring/tread elements (24, 25, 26). The spring/tread element (2, 3) is an arcuate flat spring, which, when subjected to an impact pressure load, exerts direct pressure on the springs (4a, 18, 21) in the hardness-damping system and on the shoe midsole toe (1a).

FIG. 12 shows a spring/tread element consisting of two spring/tread elements (2b, 2e). This division into two parts allows a strong correction of pronation or overpronation by means of compression or tension springs (4a, 18, 21) of different hardness and damping in the hardness-damping system (4, 4b, 4c, 4d). If only one hardness-damping system (4, 4b, 4c, 4d) is used for both spring/tread elements (2b, 2e), the pronation can also be corrected by varying the hardness of the spring/tread elements (2b, 2e).

FIG. 13 shows a spring/damping element (4d) consisting of a guide element (8) in which a compression spring (4a) is displaceably arranged in the guide element (8) and to which pressure is applied from both sides by the spring/impact elements (2, 3, 3b). Through the joint use of a compression spring (4a) in the guide element (8) that forms the spring/damper element (4d), the kinetic energy that occurs during impact loading of the spring/tread elements (2, 3, 3b) is also distributed or introduced into the spring/tread element (2) or (3, 3b), depending on the running style, and at the same time part of the energy is used for the resilient deflection of the shoe midsole (1) in the forefoot area (1a).

FIG. 14 corresponds to the technical design of FIG. 13 except for the additional spring/tread element (7a). The functional relationship between the spring/tread element (2, 3, 3b) and the additional spring/tread element (7a) is similar to that shown in FIGS. 5 and 6.

In FIG. 15, there is shown a shoe midsole (1) with three spring/tread elements (2, 10, 3), which is guided as a continuous spring band (29) with the spring/tread element (3), into a hardness-damping system (4c, 4) arranged in the hindfoot area above the heel.

Two guide elements (9, 9a) are arranged between front (2) and middle (10) and middle (10) and rear (3) spring/strike elements, in which the interconnected spring/strike elements (2, 10, 3, 3b) run displaceably. This design is advantageous for rear foot runners, with a strong heel cushioning.

FIG. 16 corresponds to the technical design as shown in FIG. 15 except for the additional spring/tread elements (11, 12). The additional spring/tread elements (11, 12) arranged between the spring/tread element (2) and (10) and between the spring/tread element (10) and (3) reinforce the kinetic interaction between the individual spring/tread elements (2, 10, 3) and the hardness-damping system (4, 4c). Alternatively, a hardness-damping system (4c) that absorbs tensile and compressive forces can be mounted in the forefoot area above the midsole at the toe of the sole (1a) to provide good walking conditions for forefoot and midfoot runners as well. In this context, the spring/tread element (11) should run higher to the ground than the spring/tread elements (2, 10, 12, 3). This embodiment is an advantageous design for a running shoe suitable for everyday use as well as for athletic use for various indoor sports.

FIGS. 17 and 18 show the spring/tread element (4) in which the free end (2a, 3a) of the spring/tread element (2, 3, 3b) is coupled to the hardness-damping system (4).

A pyramid-shaped pressure body (13) with a convex, cylindrically shaped pressure body (13a) is firmly attached to the spring/tread element (2, 3, 3b) at the free end (2a, 3a). In conjunction with the concavely shaped thrust bearing (14), a pivoting movement in one axial direction is possible. When an impact pressure load is applied to the spring/tread element (2, 3, 3a), the longitudinal displacement that occurs and the existing compressive force, at the free end (2a, 3a), are transmitted to the compression spring (4a) made of elastomer or steel introduced in the spring/tread element (4) as a compressive force.

The pyramid-shaped pressure body (13) can compensate for the wobbling movements occurring at the free end (2a, 3a) of the spring/damping element (2, 3, 3b) during impact pressure loading so that the pressure body (13) is not jammed or trapped in the spring/damping element.

The holes (15) on the spring/damping element (4) provided for screwing the spring/damping element (4) to the shoe midsole (1) can also be shaped as elongated holes in order to be able to make corrections during assembly and to enable readjustment of hardness settings.

FIG. 19 corresponds in its basic principle to FIG. 18. In this technical variant, the pressure body (13b) is cylindrical/convex and the counter bearing (14a) is concave.

FIG. 20 shows a simple solution for pressurizing a compression spring (4a) in the spring/damping element(4).

The free end (2a, 3a) at the spring/tread element (2, 3, 3b) has no fixed connection with the pressure body (13d) but lies in a trough (13c) which opens outwardly via slopes to leave sufficient space for the tumbling impact movement which the spring/tread element (2, 3, 3b) has at its free end (2a, 3a) in an axial direction.

FIG. 21 shows an attachment solution of spring/tread elements (7, 7a, 11, 12) with the spring/tread elements (2, 3, 3b, 10). Attached to the spring/tread elements (7, 7a, 11, 12) at their free ends are two or more cylindrical pins with a larger spherically shaped head (17) larger than the diameter of the cylindrical pins. At a distance from the sphere, a plate-shaped support element (30) that absorbs the pressure of the forces acting on the spring/tread elements (2, 3, 3b, 10) is arranged. On the spring/tread elements (7, 7a, 11, 12) there are bores into which a medium-hard elastomer part (16) with its annular constrictions is firmly inserted and into which the cylindrically shaped pins located on both sides of the spring/tread elements (7, 7a, 11, 12) are firmly but movably inserted with the spherically shaped head (17).

In FIG. 22, the spring/tread elements (7, 7a, 11, 12) are attached to the spring/tread elements (2, 3, 3b, 10) in a snap-fit manner similar to FIG. 21, but instead of a ball, an elongated component with a cylindrical end is used. In this case, the spring/tread elements (7, 7a, 11, 12) must be made of a medium-hard flexible material so that there is a deflection movement between the hardness-damping elements (2, 3, 3b, 10) and the medium-hardness spring/tread elements (7, 7a, 11, 12).

In FIGS. 23 and 24, a hardness-damping system (4b) is shown that allows a pushing movement of spring/tread elements (2, 2b, 2e, 3, 2d, 3, 3b) into a hardness-damping system (4b) with tension spring (18). This embodiment is advantageous for production-defined features of running shoes that are provided for different running styles and areas of use. The resilient deflection of the shoe midsole (1) when the spring/tread elements (2, 2b, 2e, 3, 2d, 3, 3b) are subjected to impact pressure in the forefoot area is influenced by a different tension spring length (18) below the spring/tread elements (2, 2b, 2e, 3, 2d, 3, 3b). With a long tension spring (18) reaching almost to the toe of the sole (1a), the resilient deflection of the shoe midsole (1) in the forefoot area is slowed down, since the tension spring (18), when tensioned, works against the deflection of the sole. In the case of a short tension spring (18) arranged outside the forefoot area at the free end (2a, 3a, 3b), there is no influence of the tension spring (18) on the resilient deflection of the sole in the forefoot area, but only the hardness-damping system of the spring/tread elements (2, 2b, 2e, 3, 2d, 3, 3b) is controlled. The tension spring (18) is advantageously made of flat rubber-like elastomer with different Shore hardness, thickness, width and tensile strength for use in different designs of running shoes. The tension spring (18) is firmly and or detachably fastened to the shoe midsole (1) by means of a screw connection (19a) and to the spring/tread element (2a, 3a) in the area (2a, 3a and 20). To enable the tension spring (18) to be replaced, holes are provided at certain intervals in the spring/tread element (2, 2b, 2e, 3, 2d, 3, 3b) to allow access to the screw connections with which the tension springs of different lengths are screwed to the shoe midsole.

The hardness-damping system (4b) with the tension spring (18) allows a short version of the spring/tread elements (2, 2b, 2e, 3, 2d, 3, 3b) in conjunction with the hardness-damping system (4b).

FIGS. 25 and 26 show a spring/tread element (2) with a hardness-damping system (4c) of a clamped (23) elastomer spring (21) in the area (2a, 3a).

In the lower third of the elastomer spring (21), a tube section (30) is embedded or vulcanized into the elastomer spring (21), with which the elastomer spring (21) is fastened to the shoe midsole by means of a screw (22). The elastomer spring (21) is clamped with its central recess (21a) in an annular recess on the spring/tread element (2, 2b, 2e, 3, 2d, 3, 3b) in the area (2a, 3a) and can be pivoted about the tube section (30). It is advantageous to use the hardness-damping system (4c) in flat spring/tread elements (2, 2b, 2e, 3, 2d, 3, 3b) , since they have a lower wobbling movement in the area (2a, 3a) when subjected to impact pressure than higherformed spring/tread elements.

FIG. 27 shows a spring/tread element (2d) which is of wing-like (2e) design and in which spacer elements (5b) are arranged under each wing (2e).

In all figures and illustrations, damping structure elements (6, 6a, 6b) are inserted under the spring/tread elements (2, 3, 3a, 10). Optionally, damping structure elements (6e, 6c, 6d) can be inserted under the spring/tread elements (7, 7a, 11, 12).

FIG. 28, FIG. 29 and FIG. 30 show a preferred embodiment of a damping structure element in the forefoot area. The spring/tread element, referred to here as shock absorber 2, is attached at the toe of the sole to a pivot hinge 35, which together with the deflection limiting band 30 is inserted into a groove 1a arranged at the toe of the sole, and these are firmly connected to the midsole 1 of the shoe. In order that the deflection limiting band 30 is kept constant in its distance height in the fastening area to the midsole 1 of the shoe, the midsole 1 of the shoe has an elevation 6 in this area. Alternatively, the elevation 6, which has a spacing or support function, can also be formed directly on the deflection limiting band 30. The deflection limiting band 30 is a wide band which, opposite the fixed side 1a, has a receptacle for an energy store 4 as a spring/damping element. The energy accumulator can be fitted with elastomer compression springs or metal springs. If elastomer springs are used, “receiving cages” must be provided in accordance with the shape of the springs so that optimum efficiency can be achieved for these specially shaped springs. In this design form of the damping structure element, the deflection limiting band 30 is not guided in a centrally arranged slot through the thrust edge 1b, but on the outside of the thrust edge 31b of the shock absorber 2 there are guide slots in which the frames 32c and 32cc of the energy store 4 slide. The frame edge 32a of the energy store forms the stop 32a against which the inner edge of the thrust edge 31b abuts. The compression springs abut the outer edge of the thrust edge 31b of the shock absorber 2 with one end and the outer frame 32d of the deflection limiting strip with their opposite side. The compression springs in the energy accumulator 4 can be formed of elastomer or steel springs. Preferably, the compression springs are made of steel, formed as wave springs with a round or rectangular cross-section. FIG. 29 shows a shoe midsole 1 which deflects upward in the ball of foot area 38 in the forefoot when subjected to an impact load and is prevented from deflecting further by the deflection limiting band 30. The distance from the deflection limiting band 30 to the midsole and the Shore hardness-damping system or spring characteristic of the compression springs used determine how far the sole deflects upwards. The design of the midsole 1 is such that it deflects more easily in the ball of the foot area than in the rest of the sole.

In FIG. 31 and FIG. 32, the energy storage unit 4 is located inside and below the shock absorber 2, respectively. The compression springs are compressed by the upstand 31a on the shock absorber and the wall 32b on the deflection limiting band 30. The advantage of this damping structure element compared to the solution of FIGS. 28 to 30 is that due to the short design, damping structure elements can also be used without problems in the midfoot and hindfoot area with small shoe dimensions. The shock absorber 2 is shaped in an arc 31b in front of the area of the energy store 4 as an example. With this shaping of the shock absorber 2 and the use of a second damping structure element in the midfoot area, the specific requirements for midfoot running can be optimally implemented.

FIGS. 33 and 34 show an example of an external energy accumulator 4, which is equipped with two compression springs 33a and 33b made of metal and a screw device 40 and 40a, with which the deflection hardness of the shock absorber 2 can be variably adjusted.

The deflection limiting band 30 is guided with the two frames 32c and 32cc on the energy absorber 4 in a guide 39 which is made of low-friction plastic and is firmly attached to the midsole.

The guide slots in the sliding edge 31b on the shock absorber 2 in which the frames 32c and 32cc slide from the energy store 4 consist of a separate part 41 and 41a made of low-friction plastic that is firmly attached to the sliding edge 31b.

In FIG. 35, a shock absorber 2 is shown with an arcuate section 31c in the front region and its attachment below the midsole 1.

With this shaping of the shock absorber 2 in the front area and the design as shown in FIG. 32, a softer cushioning of the shoe is realized.

The deflection limiting band 30 can also alternatively be fixedly connected directly to the shock absorber 2 in the front region 31c with this shaping of the shock absorber 2.

The invention is not limited to any of the above-described embodiments, but may be varied in a variety of ways.

All of the features and advantages, including constructional details, spatial arrangements and process steps, arising from the claims and the description may be essential to the invention both individually and in a wide variety of combinations.

1. A shoemidsole for running shoes with spring/damping elements (2, 4, 4a), comprising:
a bow-shaped spring/tread element (2) arrangedon the underside in the forefoot region of the shoe midsole (1), wherein the spring/tread element is fixed by a first end to the front end of the shoe midsole (1) and by its other end to a first spring/damping element (4, 4a), the direction of movement of which is parallel to the extension of the shoe midsole, so that it exerts a thrust force on the spring/tread element (2) when it flexes out.

2. The shoe midsole according to claim 1, wherein between the shoe midsole (1) and the spring/tread element (2) there is provided a deflection limiting band (30) subjected to tensile stress, which is fixed with a first end to the front end of the shoe midsole (1) and with its other end to a further or the first spring/damping element (4, 4a).

3. The shoe midsole according to claim 2, wherein the spring/tread element (2) and the deflection limiting band (30) are fixed at opposite ends of the spring/damping element (4, 4a) which is subjected to compression.

4. (canceled)

5. (canceled)

6. The shoe midsole according to claim 1, wherein the change in length of at least the one or more spring/tread element (2) occurring during impact pressure loading of the spring/tread elements (2) is used in a spring/damping element (4b) as tensile stress for a tension spring (18), the tension spring (18) runs belowabove the spring/tread element (2) and is detachably and exchangeably fastened in the region (2a, 3a) and to the shoe midsole (1) in the forefoot region (19) by means of a screw connection (19a) and is detachably and exchangeably fastened in the region (2a, 3a) and to the shoe midsole (1) in the forefoot region (19) by means of a screw connection (19a) and can be formed from elastomer or steel with different spring characteristics and lengths, and the spring/tread element (2) in the region (2a, 3a) is supported on the shoe midsole (1).

7. The shoe midsole according to claim 1, wherein the spring/tread elements (2, 3) are divided in the forefoot and rearfoot regions in the longitudinal direction of the shoe midsole (1) and are formed from two or more spring/tread elements (2b, 2e) which have their own spring damping elements (4) or use a common spring damping element (4).

8. The shoe midsole according to claim 1 wherein a spring/tread element (7) having no spring damping element of its own bridges the midfoot region and is firmly but movably connected to the spring/tread element (2) and to the spring/tread element (3b) in the midfoot region at a medium height between the underside of the shoe midsole (1) and the ground contact surface of the spring/tread elements (2, 3) in the midfoot region, and in that the spring damping element (4, 8, 4b, 4c) can be coupled to the spring/tread element (2) and (3), and in that the spring/tread element (7) can be higher than the spring/tread elements (2, 3, 3b) in athletic running shoes.

9. The shoe midsole according to claim 1, wherein a spring/tread element (2) is fixedly or pluggably and/or pivotably fastened to the sole tip (1a) and a spring/tread element (10) is fastened to the midfoot region and a spring/tread element (3) is fastened to the rear sole end (1b) of the shoe midsole (1), and the spring/tread elements (2, 10, 3) are individually coupled to a spring damping element (4, 4c, 4b, 8), and in that the spring/tread element (10) is higher than the spring damping element (4, 4c, 4b, 8) in the case of athletic running shoes, 10, 3) are individually coupled to a spring/tread element (4, 4c, 4b, 8), and in that the spring/tread element (10) can be higher than the spring/tread elements (2, 3) in athletic running shoes.

10. The shoe midsole according to claim 1, wherein a spring/tread element (2) is plugged in at the sole tip (1a) and a spring/tread element (3) is plugged in at the rear sole end (1b) of the shoe midsole (1) and is fixedly and/or pivotably fastened, and in that a spring-damping element (8) is fixedly mounted in the midfoot region of the shoe midsole (1), the compression spring (4a) in the spring/tread element (4) is displaceably connected as a loose part or fixedly connected to the spring/tread elements (2, 3) with their free ends (2a, 3a), and in that the spring/tread element (8) is formed from an upper and lower part and consists of slidable plastic.

11. The shoe midsole according to claim 1, wherein a spring/tread element (7a) is bridging the midfoot region without its own spring-damping element and is connected at mid-height between the underside of the shoe midsole (1) and the ground contact surface of the spring/tread elements (2, 3) in the metatarsal region, with the spring/tread element (2) and the spring/tread element (3) and the associated spring-damping element (8), and wherein the spring/tread element (7a) can be higher than the spring/tread elements (2, 3) in special cases.

12. The shoe midsole according to claim 1, wherein three spring/tread elements (2, 10, 3) are connected to one another to form a continuous spring/tread element (29), and a hardness-damping system (4, 4c, 4b) receives the continuous spring/tread element (29) in the backfoot region above the shoe midsole (1c), and the spring/tread element (2) is attached in a plug-in or pivotable manner to the shoe midsole (1c) in the forefoot region at the toe of the sole (1a), and that the two guide elements (9, 9a) are firmly attached to the shoe midsole (1) at the transition point from the forefoot to the midfoot region and from the midfoot to the rearfoot region and that the guide elements (9, 9a) are formed from an upper and lower part and consist of low-friction plastic.

13. (canceled)

14. The shoe midsole according to claim 1, wherein the spring/tread element (2, 2d, 2e, 2b, 3, 3b, 7, 7a, 10, 11, 12, 24, 25, 26, 27) has one or more channel-shaped depressions (3b/R) transverse to the central axis or deviated by up to 10 degrees, and in that the spring/tread elements (2, 2d, 2e, 2b, 3, 3a, 7, 7a, 10, 11, 12, 24, 25, 26, 27) can have a different vertical, curvilinear or arcuate shape in the longitudinal and transverse directions, can be concave, convex or have a free curvilinear shape, and the channel-shaped depressions (3b/R) extend to below the deepest points of the surface deformation, so that the spring/tread element can be bent in the longitudinal direction of the shoe midsole (1) despite its surface deformation.

15. The shoe midsole according to claim 1, wherein the spring/tread elements (2, 2a, 2b, 3, b 10, 7a, 7, 24, 25, 26, 27) or the shoe midsole (1), have, on the side facing a damping structural element (6, 6a, 6b, 6e, 6c, 6d), one or more spacer elements (5, 5a, 5b) which are concave or convex, or cylindrically shaped extending transversely to the central axis in the form of strips or are cylindrically shaped and the shoe midsole (1) and the spring/tread element (2, 2a, 2b, 3, b 10, 7a, 7, 24, 25, 26, 27) contact each other by means of the spacer elements through openings in the damping structural elements (6, 6a, 6e, 6b, 6c, 6d) upon impact and that the residual height is limited to approx. 35% of the existing total height between the intermediate shoe sole (1) and the spring/tread elements.

16. (canceled)

17. (canceled)

18. The shoe midsole according to claim 1, whereinthe individual spring/tread elements (2, 2e, 2b, 2d, 3, 24, 25, 26, 27) is selectively coupled to the individual spring-damping elements (4, 4b, 4c, 8), and in that the individual spring/tread elements (2, 2e, 2b, 2d, 3, 24, 25, 26, 27) are supported with the opposite pressure-stable side (2a, 2b, 2e, 3a) on the shoe midsole (1) in front of the hardness damping system (4, 8, 4c) by means of two parallel guide tracks which are arranged on the shoe midsole (1) with approx. a height of 2 to 4 mm or elevations belowabove the pressure-stable side (2a, 2b, 2e, 3a), and or that a hinge is arranged at the transition to the pressure-stable side (2a, 2b, 2e, 3a), resting with the corresponding diameter on the shoe midsole (1) to allow a central height of the pressure-stable sides (2a, 2b, 2e, 3a) in the spring damping element (4, 4b, 4c, 8) for linear guidance.

19. The shoe midsole according to claim 1, wherein a gas pressure spring or a mini-hydraulic system adjustable in hardness and damping is used in the individual spring/tread elements (4, 4b, 4c, 8), which are firmly but pivotably connected to the spring/tread elements (2, 2e, 2b, 2d, 3, 24, 25, 26, 27) and the hardness-damping system (4, 8).

20. The shoe midsole according to claim 1, wherein individual outsole coverings or complete outsoles made of technical foams can be attached by means of known hook-and-loop fastener solutions to the spring/tread elements (2, 2a, 2b, 3,b 10, 7a, 7, 24, 25, 26, 27) or to partial segments of the shoe midsole (1) by means of known hook-and-loop fastener solutions, the outsole coverings or complete outsoles having a different contour along or transverse to the central axis of the sole than the spring/tread elements (2, 2a, 2b, 3,b 10, 7a, 7, 24, 25, 26, 27) and with respect to the shoe midsole (1), and in that the surface of the outsole coverings have different structures and material properties which can be used for different types of running and sports, and in that a complete continuous outsole made of technical foams can be firmly connected to the shoe midsole by adhesive bonding, closable openings being provided in the spring damping element (4, 4c, 4b, 8) for the replacement of compression or tension springs (4a, 21, 18).

21. The shoe midsole according to claim 1, wherein the non-linear thrust movement of the spring/tread elements (2, 2a, 2b, 3,b 10, 7a, 7, 24, 25, 26, 27) at its free ends (2, 2e, 2b, 3a), which are wobbling in an axial direction, is guided into the spring-damping element (4), are structurally converted into a linear thrust movement by pivotable pressure receivers (13, 14, 13b, 13c, 14a), and in that, in special cases, the spring/tread elements (2, 2a, 2b, 3,b 10, 7a, 7, 24, 25, 26, 27) are fixedly connected by their free end (2a, 3a) to the compression springs (4a) in the spring-damping element (4).

22. The shoe midsole according to claim 1, wherein the spring/tread elements (2, 2a, 2b, 3,b 10, 7a, 7, 24, 25, 26, 27) are formed from carbon-fiber-reinforced plastic, and their different use in running shoes with the differently required spring stiffnesses is determined in dependence on the damping structural elements (6, 6a, 6e, 6b, 6c, 6d) used, and when the damping and hardness properties of the individual spring/tread elements (2, 2a, 2b, 3, b 10, 7a, 7, 24, 25, 26, 27) are matched to the spring/tread elements, the individual spring/tread elements can be formed from medium-hard TPEE-based plastic, and, in that the continuous spring/tread element (29) formed from the spring/tread element (2, 10, 3) and the continuous spring/tread element formed from the spring/tread element (2, 11, 10, 12, 3) can be manufactured continuously in a manufacturing process.

23. The shoe midsole according to claim 1, wherein the spring/tread elements (2, 2a, 2b, 3, b 10, 7a, 7, 24, 25, 26, 27) hasa height of between 20 mm and 40 mm in accordance with their use in different sports and running shoes, and, that the height of individual spring/tread elements located on the shoe midsole (1) can differ in height and hardness from other spring/tread elements attached to the shoe midsole (1), and in that the spring/tread elements (2, 2d, 2b, 2e, 3, 3b, 10, 24, 25, 26, 27) have different types of fastening (1a, 1b, 1c, 1d, 1e, 1f) on their fastening side to the shoe midsole (1) in accordance with the intended use, and the spring/tread elements (2, 2d, 2b, 2e, 3, 3b, 10, 24, 25, 26 27) can be structurally different in their spring characteristics and their construction height and spring shaping and can be used for defined walking styles and places of use.

24. The shoe midsole according to claim 1, wherein the shoe midsole (1) can be deflected resiliently in the ball region (38) of the forefoot, and a spring/tread element (2) is mounted pivotably with one side and is inserted fixedly by means of a hinge (35) into a receptacle (1a) at the shoe midsole tip (14) of the shoe midsole (4), and the spring/tread element (1) rests with its opposite side on the shoe midsole (4) or the deflection-limiting band (30) and the spring/tread element (2) rests with its opposite side on the shoe midsole (4) or on the deflection-limiting band (30), that the deflection limiting band (30) extending above the spring/tread element (2) is firmly inserted with one side into the receptacle (1a) and with the opposite side runs in openings through the thrust edge (31b) on the spring/tread element (2) and or in lateral guides on the thrust edge (31b) on the spring/tread element (2) in which the frames (32c, 32cc) are guided and that in the deflection limiting band (30) behind the thrust edge (31b) on the spring/tread element (2) there is a spring/damping element (4) acting as an energy store with at least one compression spring (4a) made of metal or elastomer and cushions, damps and stores in the form of energy the occurring linear thrust load of the thrust edge (31b) which is produced by an impact load of the spring/tread element (2) and the associated compression.

25. (canceled)

26. (canceled)

27. (canceled)

28. (canceled)

29. The shoe midsole according to claim 1, wherein the spring/tread element (2) can be shaped differently according to the type of use and the different running styles, can have different spring shapes with different spring characteristics or Shore hardness in the transverse and longitudinal directions, and can have different curvatures or curved shapes in conjunction with different heights of the individual spring/tread elements (2) of approx. 15 mm to a maximum of 40 mm, and is formed from materials such as carbon or medium-hard plastics with different degrees of flex, and the connection to the shoe midsole (1) at the sole tip, in the midfoot region or at the rear shoe midsole end in the backfoot region can be made pivotably by means of a hinge (35) or firmly (42) by bonding, welding or plug-in connections.

30. (canceled)

31. (canceled)

32. (canceled)
